(19) United States
(12) Patent Application Publication
(10) Pub. No.: US 2024/0209674 A1
(43) Pub. Date: Jun. 27, 2024

(54) DOOR CONTROL DEVICE

(71) Applicant: AISIN CORPORATION, Kariya (JP)

(72) Inventors: Kenta IZUMI, Kariya-shi (JP); Kai ISHIKO, Kariya-shi (JP); Yuji NISHI, Kariya-shi (JP)

(73) Assignee: AISIN CORPORATION, Kariya (JP)

(21) Appl. No.: 18/536,549

(22) Filed: Dec. 12, 2023

(30) Foreign Application Priority Data
Dec. 27, 2022 (JP) 2022-209617

(51) Int. Cl. E05F 15/73; B60J 5/04; B60J 5/06; E05F 15/40

(52) U.S. Cl. CPC E05F 15/73; B60J 5/0479; B60J 5/062; E05F 15/40; E05Y 2400/45; E05Y 2900/531

(57) ABSTRACT

A door control device is applied to a vehicle including a vehicle body having a first opening and a second opening adjacent to each other, a first door configured to open and close the first opening, a second door configured to open and close the second opening, a first drive unit configured to open and close the first door between a fully open position where the first opening is fully opened and a fully closed position where the first opening is fully closed, and a second drive unit configured to open and close the second door between a fully open position where the second opening is fully opened and a fully closed position where the second opening is fully closed. The door control device includes: a first control unit configured to control the first drive unit based on the operation command signal; and a second control unit configured to control the second drive unit based on the operation command signal, the operation command signal being a signal for operating both the first door and the second door. When the operation command signal is transmitted to the first control unit and the second control unit while the first door and the second door are stopped, the first control unit starts an operation of the first door and the second control unit starts an operation of the second door, and when the operation command signal is transmitted to the first control unit and the second control unit while at least one of the first door and the second door is in an opening and closing operation, the first control unit restricts the operation of the first door, and the second control unit restricts the operation of the second door.

### CROSS REFERENCE TO RELATED APPLICATIONS

This application is based on and claims priority under 35 U.S.C. § 119 to Japanese Patent Application 2022-209617, filed on Dec. 27, 2022, the entire content of which is incorporated herein by reference.

### TECHNICAL FIELD

This disclosure relates to a door control device.

### BACKGROUND DISCUSSION

JP 2005-88813A (Reference 1) discloses a vehicle including a vehicle body having a door opening that opens to a side portion, a first door that opens and closes a front half of the door opening, and a second door that opens and closes a rear half of the door opening. The first door and the second door are electrically opened or closed according to an operation of an operation button by a user.

It is preferable that the vehicle as described above does not give a sense of danger to the user when the first door and the second door are opened and closed according to the operation of the operation button.

### SUMMARY

According to an aspect of this disclosure, a door control device that solves the above problems is a door control device applied to a vehicle including a vehicle body having a first opening and a second opening adjacent to each other, a first door configured to open and close the first opening, a second door configured to open and close the second opening, a first drive unit configured to open and close the first door between a fully open position where the first opening is fully opened and a fully closed position where the first opening is fully closed, and a second drive unit configured to open and close the second door between a fully open position where the second opening is fully opened and a fully closed position where the second opening is fully closed. The door control device includes: a first control unit configured to control the first drive unit based on the operation command signal; and a second control unit configured to control the second drive unit based on the operation command signal, the operation command signal being a signal for operating both the first door and the second door. When the operation command signal is transmitted to the first control unit and the second control unit while the first door and the second door are stopped, the first control unit starts an operation of the first door and the second control unit starts an operation of the second door, and when the operation command signal is transmitted to the first control unit and the second control unit while at least one of the first door and the second door is in an opening and closing operation, the first control unit restricts the operation of the first door, and the second control unit restricts the operation of the second door.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram of a vehicle including a door control device;

FIG. 2 is a table showing changes in operation modes of a first door and a second door when a two-door opening switch is operated;

FIG. 3 is a table showing changes in the operation modes of the first door and the second door when a two-door closing switch is operated;

FIG. 4 is a flowchart showing a flow of processing performed by a first control unit when the two-door opening switch is operated;

FIG. 5 is a flowchart showing a flow of processing performed by a second control unit when the two-door opening switch is operated; and

FIG. 6 is a table showing changes in operation modes of a first door and a second door when a two-door opening and closing switch is operated in a modification.

### DETAILED DESCRIPTION

Hereinafter, an embodiment of a vehicle including a door control device will be described.

### Configuration of Embodiment

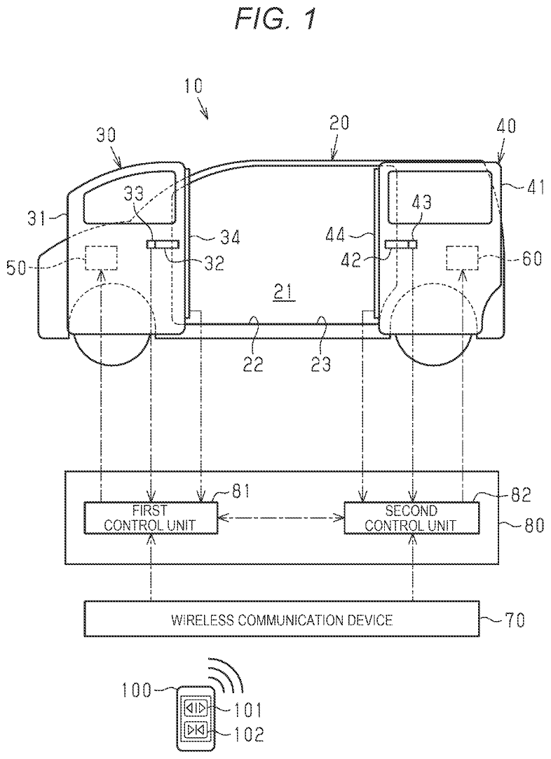

As shown in FIG. 1, a vehicle 10 includes a vehicle body 20, a first door 30, a second door 40, a first drive unit 50, a second drive unit 60, a wireless communication device 70, and a door control device 80.

### Vehicle Body 20

The vehicle body 20 includes a door opening 21 that opens to a side portion. The door opening 21 has a rectangular shape whose longitudinal direction is a front-rear direction and whose short direction is an up-down direction. The door opening 21 includes a first opening 22 and a second opening 23 adjacent to each other in the front-rear direction. The first opening 22 and the second opening 23 are connected in the front-rear direction. The first opening 22 is a front portion of the door opening 21, and the second opening 23 is a rear portion of the door opening 21. In the embodiment, the first opening 22 corresponds to a front half of the door opening 21, and the second opening 23 corresponds to a rear half of the door opening 21. In another embodiment, the first opening 22 and the second opening 23 may have different sizes.

### First Door 30 and First Drive Unit 50

The first door 30 includes a door body 31, a door handle 32, a door switch 33, and a touch sensor 34. The door body 31 has a shape corresponding to the first opening 22 in a side view in a width direction. The door body 31 is supported by the vehicle body 20 to be slidable in the front-rear direction. The door handle 32 is an outside door handle provided outside the door body 31. The first door 30 may include an inside door handle inside the door body 31. The door switch 33 is provided near the door handle 32. The door switch 33 is a switch operated by a user. When operated, the door switch 33 outputs a first operation command signal for operating the first door 30. The touch sensor 34 is provided along a rear end edge of the door body 31. When an external force acts on the touch sensor 34, a contact state of a plurality of electrodes provided therein changes. The touch sensor 34 outputs a stop command signal for stopping the first door 30 during a closing operation when the contact state of the electrodes changes due to contact with an object or the like. The touch sensor 34 corresponds to a “first touch sensor”.

The first drive unit 50 includes, for example, an electric motor serving as a drive source, and a conversion mechanism that converts a rotational movement of an output shaft of the electric motor into a back-and-forth movement of the first door 30. The first drive unit 50 is disposed inside the first door 30 or near the door opening 21 in the vehicle body 20. The first drive unit 50 opens and closes the first door 30 between a fully open position where the first opening 22 is fully opened and a fully closed position where the first opening 22 is fully closed. An opening direction of the first door 30 is forward, and a closing direction of the first door 30 is rearward. In this respect, the first door 30 corresponds to a “front slide door” that opens and closes the first opening 22 by sliding in the front-rear direction.

### Second Door 40 and Second Drive Unit 60

The second door 40 includes a door body 41, a door handle 42, a door switch 43, and a touch sensor 44. The door body 41 has a shape corresponding to the second opening 23 in a side view in the width direction. The door body 41 is supported by the vehicle body 20 to be slidable in the front-rear direction. The door handle 42 is an outside door handle provided outside the door body 41. The second door 40 may include an inside door handle inside the door body 41. The door switch 43 is provided near the door handle 42. The door switch 43 is a switch operated by a user. When operated, the door switch 43 outputs a second operation command signal for operating the second door 40. The touch sensor 44 is provided along a front end edge of the door body 41. When an external force acts on the touch sensor 44, a contact state of a plurality of electrodes provided therein changes. The touch sensor 44 outputs a stop command signal for stopping the second door 40 during a closing operation when the contact state of the electrodes changes due to contact with an object or the like. The touch sensor 44 corresponds to a “second touch sensor”.

The second drive unit 60 includes, for example, an electric motor serving as a drive source, and a conversion mechanism that converts a rotational movement of an output shaft of the electric motor into a back-and-forth movement of the second door 40. The second drive unit 60 is disposed inside the second door 40 or near the door opening 21 in the vehicle body 20. The second drive unit 60 opens and closes the second door 40 between a fully open position where the second opening 23 is fully opened and a fully closed position where the second opening 23 is fully closed. An opening direction of the second door 40 is rearward, and a closing direction of the second door 40 is forward. In this respect, the second door 40 corresponds to a “rear slide door” that opens and closes the second opening 23 by sliding in the front-rear direction.

### Wireless Communication Device 70 and Portable Device 100

A portable device 100 includes a switch for operating the first door 30 and the second door 40. In the embodiment, the portable device 100 includes a two-door opening switch 101 for opening both the first door 30 and the second door 40, and a two-door closing switch 102 for closing both the first door 30 and the second door 40. The portable device 100 may be an electronic key, a smartphone, or another communication terminal. The wireless communication device 70 determines whether the portable device 100 is the portable device 100 that is associated with the vehicle 10 by performing wireless communication with the portable device 100 located around the vehicle 10.

The wireless communication device 70 outputs, based on a signal transmitted from the portable device 100, an operation command signal for operating a slide door to the door control device 80. Specifically, when the two-door opening switch 101 of the portable device 100 is operated, the wireless communication device 70 outputs an opening operation command signal for opening both the first door 30 and the second door 40. On the other hand, when the two-door closing switch 102 of the portable device 100 is operated, the wireless communication device 70 outputs a closing operation command signal for closing both the first door 30 and the second door 40.

### Door Control Device 80

The door control device 80 includes a first control unit 81 that controls the first drive unit 50 and a second control unit 82 that controls the second drive unit 60.

The first control unit 81 and the second control unit 82 are each implemented by a processing circuit including a computer and a memory. The processing circuit implementing the first control unit 81 and the processing circuit implementing the second control unit 82 may be mounted on different substrates or may be mounted on the same substrate. In the former case, the processing circuit implementing the first control unit 81 is preferably disposed near the first drive unit 50, and the processing circuit implementing the second control unit 82 is preferably disposed near the second drive unit 60.

Various signals are transmitted from the door switch 33, the touch sensor 34, the wireless communication device 70, and the second control unit 82 to the first control unit 81. The first control unit 81 controls the first drive unit 50 based on the received various types of information. That is, the first control unit 81 controls the operation of the first door 30. When operating the first door 30 to open and close, the first control unit 81 calculates a position of the first door 30 during the opening and closing operation according to a rotation amount of the output shaft of the electric motor of the first drive unit 50.

Similarly, various signals are transmitted from the door switch 43, the touch sensor 44, the wireless communication device 70, and the first control unit 81 to the second control unit 82. The second control unit 82 controls the second drive unit 60 based on the received various types of information. That is, the second control unit 82 controls the operation of the second door 40. When operating the second door 40 to open and close, the second control unit 82 calculates a position of the second door 40 during the opening and closing operation according to a rotation amount of the output shaft of the electric motor of the second drive unit 60.

Hereinafter, a user who carries the portable device 100 is also referred to as a first user, and a user who gets on and off the vehicle 10 through the first opening 22 and the second opening 23 is also referred to as a second user. In other words, the first user can operate the portable device 100, and the second user can operate the door switches 33 and 43. The first user and the second user may be the same user.

Door Control when Door Switch 33 is Operated

When the second user operates the door switch 33, in other words, when the first operation command signal is transmitted from the door switch 33, the first control unit 81 opens and closes the first door 30. Specifically, when the first operation command signal is transmitted while the first door 30 is stopped at the fully closed position, the first control unit 81 opens the first door 30. On the other hand, when the first operation command signal is transmitted while the first door 30 is stopped at the fully open position, the first control unit 81 closes the first door 30. In addition, when the first operation command signal is transmitted while the first door 30 is in the opening and closing operation, the first control unit 81 stops the first door 30. In this case, the first door 30 stops at an intermediate position between the fully closed position and the fully open position. When the first operation command signal is transmitted while the first door 30 is stopped at the intermediate position, the first control unit 81 may operate the first door 30 in an operation direction before the stop or may operate the first door 30 in a direction set in advance. Similarly, the second control unit 82 operates or stops the second door 40 based on the position of the second door 40 and the second operation command signal transmitted from the door switch 43. In the following description, the opening and closing operation of the first door 30 and the opening and closing operation of the second door 40 based on the first operation command signal and the second operation command signal are also referred to as normal operations.

Door Control when Object is in Contact with Door during Closing Operation

When the stop command signal is transmitted from the touch sensor 34 during the closing operation of the first door 30, the first control unit 81 reverses the operation direction of the first door 30. That is, the first door 30 is opened toward the fully open position. Hereinafter, such an operation of the first door 30 is referred to as a reverse operation. Similarly, the second control unit 82 causes the second door 40 to perform the reverse operation based on an operation state of the second door 40 and the stop command signal transmitted from the touch sensor 44.

Door Control when Load of Drive Unit increases During Opening and Closing Operation of Door

When a load of the electric motor of the first drive unit 50 increases during the opening and closing operation of the first door 30, the first control unit 81 reverses the operation direction of the first door 30. That is, the first control unit 81 causes the first door 30 to perform the reverse operation. Similarly, when the load of the electric motor of the second drive unit 60 increases during the opening and closing operation of the second door 40, the second control unit 82 causes the second door 40 to perform the reverse operation.

Door Control when Two-Door Opening Switch 101 is Operated

When the first user operates the two-door opening switch 101 of the portable device 100, that is, when the opening operation command signal is transmitted, the first control unit 81 determines whether to start or restrict the opening operation of the first door 30 based on various types of information. Similarly, when the first user operates the two-door opening switch 101 of the portable device 100, that is, when the opening operation command signal is transmitted, the second control unit 82 determines whether to start or restrict the opening operation of the second door 40 based on various types of information.

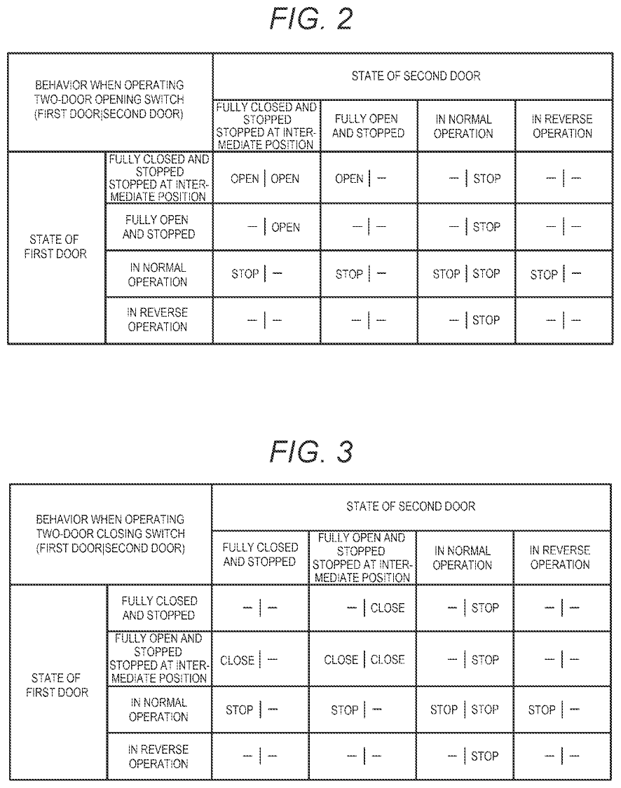

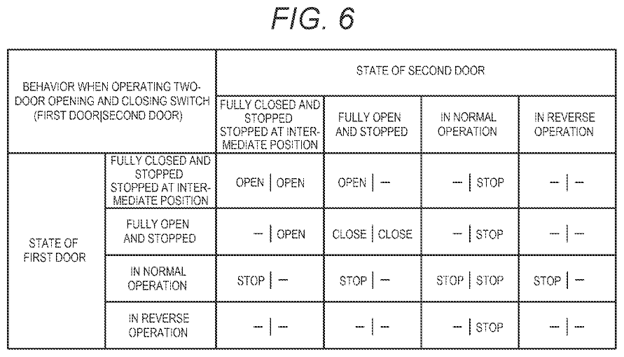

Hereinafter, a detailed description will be given with reference to FIG. 2. FIG. 2 is a table showing how operation modes of the first door 30 and the second door 40 change when the opening operation command signal is transmitted while the first door 30 and the second door 40 are in various states. In columns indicating the changes in the operation modes, a left side of “|” indicates the changes in the operation modes of the first door 30, and a right side of “|” indicates the changes in the operation modes of the second door 40. In the columns indicating the changes in the operation modes, “-” indicates that there is no change in the operation mode. In other words, “-” indicates that the operation mode is continued. The same applies to FIGS. 3 and 6.

When the first door 30 and the second door 40 are stopped at the fully closed positions or the intermediate positions, in other words, when the first door 30 and the second door 40 are stopped at positions different from the fully open position, both the first door 30 and the second door 40 are in a state of being able to perform the opening operation. Therefore, when the opening operation command signal is transmitted while the first door 30 and the second door 40 are stopped at positions different from the fully open position, the first control unit 81 starts the opening operation of the first door 30, and the second control unit 82 starts the opening operation of the second door 40.

When the first door 30 and the second door 40 are stopped at the fully open positions, the first door 30 and the second door 40 are not in the state of being able to perform the opening operation. Therefore, when the opening operation command signal is transmitted while the first door 30 and the second door 40 are stopped at the fully open positions, the first control unit 81 restricts the opening operation of the first door 30, and the second control unit 82 restricts the opening operation of the second door 40. That is, the first control unit 81 maintains the state in which the first door 30 is stopped at the fully open position, and the second control unit 82 maintains the state in which the second door 40 is stopped at the fully open position.

When the first door 30 is stopped at a position different from the fully open position and the second door 40 is stopped at the fully open position, the first door 30 is in the state of being able to perform the opening operation, but the second door 40 is not in the state of being able to perform the opening operation. Therefore, when the opening operation command signal is transmitted while the first door 30 is stopped at a position different from the fully open position and the second door 40 is stopped at the fully open position, the first control unit 81 starts the opening operation of the first door 30, and the second control unit 82 restricts the opening operation of the second door 40. Similarly, when the opening operation command signal is transmitted while the first door 30 is stopped at the fully open position and the second door 40 is stopped at a position different from the fully open position, the first control unit 81 restricts the opening operation of the first door 30, and the second control unit 82 starts the opening operation of the second door 40.

When the first door 30 is stopped and the second door 40 is in the normal operation, there is a high possibility that the second door 40 is opened and closed based on the operation of the door switch 43 performed by the second user. Therefore, when the first door 30 is opened or the operation mode of the second door 40 is changed based on the operation of the two-door opening switch 101 of the portable device 100 performed by the first user, the second user may feel uncomfortable. In addition, in such a situation, when the opening operation command signal is transmitted, there is a possibility that the first user erroneously operates the two-door opening switch 101 in an attempt to immediately stop the second door 40 during the normal operation. Therefore, when the opening operation command signal is transmitted while the first door 30 is stopped and the second door 40 is in the normal operation, the first control unit 81 restricts the opening operation of the first door 30, and the second control unit 82 restricts the opening operation of the second door 40. At this time, the second control unit 82 stops the second door 40 that is in operation.

Similarly, when the opening operation command signal is transmitted while the first door 30 is in the normal operation and the second door 40 is stopped, the first control unit 81 restricts the opening operation of the first door 30, and the second control unit 82 restricts the opening operation of the second door 40. Further, when the opening operation command signal is transmitted while the first door 30 and the second door 40 are in the normal operation, the first control unit 81 restricts the opening operation of the first door 30, and the second control unit 82 restricts the opening operation of the second door 40.

When the first door 30 is in the reverse operation, the reverse operation of the first door 30 is preferably continued in order to eliminate a state in which the first door 30 comes into contact with or approaches an object. Therefore, when the opening operation command signal is transmitted while the first door 30 is in the reverse operation and the second door 40 is not in the reverse operation, the first control unit 81 continues the reverse operation of the first door 30, and the second control unit 82 restricts the operation of the second door 40. At this time, the second control unit 82 keeps the second door 40 stopped when the second door 40 is stopped, and stops the operation of the second door 40 when the second door 40 is in the normal operation. Similarly, when the opening operation command signal is transmitted while the first door 30 is not in the reverse operation but the second door 40 is in the reverse operation, the first control unit 81 restricts the operation of the first door 30, and the second control unit 82 continues the reverse operation of the second door 40. Further, when the opening operation command signal is transmitted while the first door 30 and the second door 40 are in the reverse operation, the first control unit 81 and the second control unit 82 continue the reverse operation.

Door Control when Two-Door Closing Switch 102 is Operated

Control modes of the doors when the two-door closing switch 102 of the portable device 100 is operated are substantially the same as control modes of the doors when the two-door opening switch 101 of the portable device 100 is operated except that the operation directions of the first door 30 and the second door 40 are different. Therefore, a part of the following description will be omitted.

When the user operates the two-door closing switch 102 of the portable device 100, in other words, when the closing operation command signal is received, the first control unit 81 determines whether to start or restrict the closing operation of the first door 30 based on various types of information. Similarly, when the user operates the two-door closing switch 102 of the portable device 100, in other words, when the closing operation command signal is received, the second control unit 82 determines whether to start or restrict the closing operation of the second door 40 based on various types of information.

Hereinafter, a detailed description will be given with reference to FIG. 3. FIG. 3 is a table showing how the operation modes of the first door 30 and the second door 40 change when the closing operation command signal is transmitted while the first door 30 and the second door 40 are in various states.

When the closing operation command signal is transmitted while the first door 30 and the second door 40 are stopped at the fully closed position, the first control unit 81 restricts the closing operation of the first door 30, and the second control unit 82 restricts the closing operation of the second door 40.

When the closing operation command signal is transmitted while the first door 30 and the second door 40 are stopped at positions different from the fully closed position, the first control unit 81 starts the closing operation of the first door 30, and the second control unit 82 starts the closing operation of the second door 40.

When the closing operation command signal is transmitted while the first door 30 is stopped at a position different from the fully closed position and the second door 40 is stopped at the fully closed position, the first control unit 81 starts the closing operation of the first door 30, and the second control unit 82 restricts the closing operation of the second door 40. Similarly, when the closing operation command signal is transmitted while the first door 30 is stopped at the fully closed position and the second door 40 is stopped at a position different from the fully closed position, the first control unit 81 restricts the closing operation of the first door 30, and the second control unit 82 starts the closing operation of the second door 40.

When the closing operation command signal is transmitted while the first door 30 is stopped and the second door 40 is in the normal operation, the first control unit 81 restricts the closing operation of the first door 30, and the second control unit 82 restricts the closing operation of the second door 40. At this time, the second control unit 82 stops the second door 40 that is in operation. Similarly, when the closing operation command signal is transmitted while the first door 30 is in the normal operation and the second door 40 is stopped, the first control unit 81 restricts the closing operation of the first door 30, and the second control unit 82 restricts the closing operation of the second door 40. At this time, the first control unit 81 stops the first door 30 that is in operation. Further, when the closing operation command signal is transmitted while the first door 30 and the second door 40 are in the normal operation, the first control unit 81 restricts the closing operation of the first door 30, and the second control unit 82 restricts the closing operation of the second door 40.

When the closing operation command signal is transmitted while the first door 30 is in the reverse operation and the second door 40 is not in the reverse operation, the first control unit 81 continues the reverse operation of the first door 30, and the second control unit 82 restricts the operation of the second door 40. At this time, the second control unit 82 keeps the second door 40 stopped when the second door 40 is stopped, and stops the operation of the second door 40 when the second door 40 is in the normal operation. Similarly, when the closing operation command signal is transmitted while the first door 30 is not in the reverse operation but the second door 40 is in the reverse operation, the first control unit 81 restricts the operation of the first door 30, and the second control unit 82 continues the reverse operation of the second door 40. At this time, the first control unit 81 keeps the first door 30 stopped when the first door 30 is stopped, and stops the operation of the first door 30 when the first door 30 is in the normal operation. Further, when the closing operation command signal is transmitted while the first door 30 and the second door 40 are in the reverse operation, the first control unit 81 and the second control unit 82 continue the reverse operation.

### Opening and Closing Determination Processing

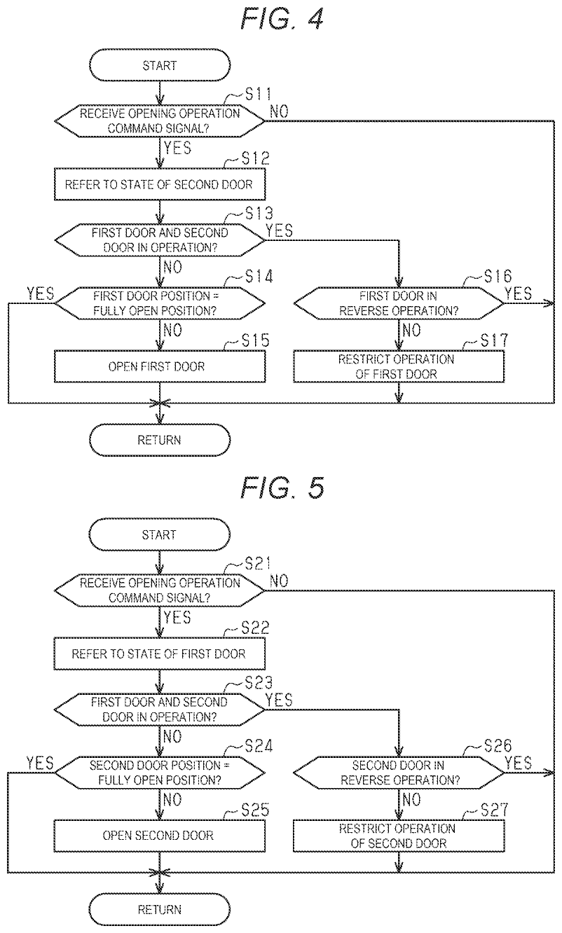

With reference to FIG. 4, processing performed by the first control unit 81 to determine whether to open the first door 30 based on an operation of the two-door opening switch 101 will be described. The processing is repeatedly performed in a predetermined control cycle when the vehicle 10 is stopped.

As shown in FIG. 4, the first control unit 81 determines whether an opening operation command signal is received (S11). When the opening operation command signal is not received (S11: NO), that is, when the first user is not operating the two-door opening switch 101, the first control unit 81 temporarily ends the processing. On the other hand, when the opening operation command signal is received (S11: YES), that is, when the first user operates the two-door opening switch 101, the first control unit 81 refers to information on the second door 40 by communicating with the second control unit 82 (S12). The information on the second door 40 includes information indicating whether the second door 40 is in operation and information indicating a current position of the second door 40. Thereafter, the first control unit 81 determines whether at least one of the first door 30 and the second door 40 is in operation (S13).

When both the first door 30 and the second door 40 are not in operation (S13: NO), in other words, when the first door 30 and the second door 40 are stopped, the first control unit 81 determines whether a position of the first door 30 is a fully open position (S14). When the position of the first door 30 is the fully open position (S14: YES), that is, when the first door 30 is not in a state of being able to perform the opening operation, the first control unit 81 ends the processing. On the other hand, when the position of the first door 30 is not the fully open position (S14: NO), that is, when the first door 30 is in the state of being able to perform the opening operation, the first control unit 81 starts the opening operation of the first door 30 (S15). Thereafter, when the first door 30 reaches the fully open position, the opening operation of the first door 30 is completed. Then, the first control unit 81 ends the processing.

In step S13, when at least one of the first door 30 and the second door 40 is in operation (S13: YES), the first control unit 81 determines whether the first door 30 is in the reverse operation (S16). When the first door 30 is in the reverse operation (S16: YES), the first control unit 81 ends the processing. That is, the first control unit 81 continues the reverse operation.

On the other hand, when the first door 30 is not in the reverse operation (S16: NO), the first control unit 81 restricts the operation of the first door 30 (S17). For example, the first control unit 81 keeps the first door 30 stopped when the first door 30 is stopped, and stops the first door 30 when the first door 30 is in the normal operation. Thereafter, the first control unit 81 ends the processing.

With reference to FIG. 5, processing performed by the second control unit 82 to determine whether to open the second door 40 based on an operation of the two-door opening switch 101 will be described. The processing is repeatedly performed in a predetermined control cycle when the vehicle 10 is stopped.

As shown in FIG. 5, the second control unit 82 determines whether an opening operation command signal is received (S21). When the opening operation command signal is not received (S21: NO), that is, when the second user is not operating the two-door opening switch 101, the second control unit 82 temporarily ends the processing. On the other hand, when the opening operation command signal is received (S21: YES), that is, when the second user operates the two-door opening switch 101, the second control unit 82 refers to information on the first door 30 by communicating with the first control unit 81 (S22). The information on the first door 30 includes information indicating whether the first door 30 is in operation and information indicating a current position of the first door 30. Thereafter, the second control unit 82 determines whether at least one of the first door 30 and the second door 40 is in operation (S23).

When both the first door 30 and the second door 40 are not in operation (S23: NO), in other words, when the first door 30 and the second door 40 are stopped, the second control unit 82 determines whether a position of the second door 40 is a fully open position (S24). When the position of the second door 40 is the fully open position (S24: YES), that is, when the second door 40 is not in a state of being able to perform the opening operation, the second control unit 82 ends the processing. On the other hand, when the position of the second door 40 is not the fully open position (S24: NO), that is, when the second door 40 is in the state of being able to perform the opening operation, the second control unit 82 starts the opening operation of the second door 40 (S25). Thereafter, when the second door 40 reaches the fully open position, the opening operation of the second door 40 is completed. Then, the second control unit 82 ends the processing.

In step S23, when at least one of the first door 30 and the second door 40 is in operation (S23: YES), the second control unit 82 determines whether the second door 40 is in the reverse operation (S26). When the second door 40 is in the reverse operation (S26: YES), the second control unit 82 ends the processing. That is, the second control unit 82 continues the reverse operation.

On the other hand, when the second door 40 is not in the reverse operation (S26: NO), the second control unit 82 restricts the operation of the second door 40 (S27). For example, the second control unit 82 keeps the second door 40 stopped when the second door 40 is stopped, and stops the second door 40 when the second door 40 is in the normal operation. Thereafter, the second control unit 82 ends the processing.

The processing of determining whether to perform the closing operation of the first door 30 based on the operation of the two-door closing switch 102 is substantially the same as the processing of determining whether to perform the opening operation of the first door 30 based on the operation of the two-door opening switch 101, and thus the description thereof will be omitted. The processing of determining whether to perform the closing operation of the first door 30 based on the operation of the two-door closing switch 102 is the same as the processing of replacing the “opening operation” as the “closing operation” and replacing the “fully open position” as the “fully closed position” in the flowchart shown in FIG. 4.

Similarly, the processing of determining whether to perform the closing operation of the second door 40 based on the operation of the two-door closing switch 102 is substantially the same as the processing of determining whether to perform the opening operation of the second door 40 based on the operation of the two-door opening switch 101, and thus the description thereof will be omitted. The processing of determining whether to perform the closing operation of the second door 40 based on the operation of the two-door closing switch 102 is the same as the processing of replacing the “opening operation” as the “closing operation” and replacing the “fully open position” as the “fully closed position” in the flowchart shown in FIG. 5.

### Operation of Embodiment

The operation of the door control device 80 in a situation in which the vehicle 10 is stopped, the first door 30 is located at the fully closed position, and the second door 40 is located at the fully open position will be described.

In the above situation, when the second user wants to close the second door 40 from the fully open position, the second user operates the door switch 43 of the second door 40. Then, the second door 40 closes from the fully open position to the fully closed position. Here, when the first user does not recognize the operation states of the first door 30 and the second door 40, there is a possibility that the first user operates the two-door opening switch 101 even though the second door 40 is in the closing operation. When the first user operates the two-door opening switch 101 while the second door 40 is in the closing operation, the opening operations of the first door 30 and the second door 40 are restricted. Specifically, the first door 30 does not open from the fully closed position. In addition, the second door 40 is immediately stopped. In this way, when the two-door opening switch 101 and the two-door closing switch 102 are operated against the operation states of the first door 30 and the second door 40, the operations of the first door 30 and the second door 40 are restricted. However, when the first user operates the two-door opening switch 101 while the second door 40 is in the reverse operation, the opening operation of the first door 30 is restricted, whereas the reverse operation of the second door 40 is not restricted.

### Effects of Embodiment

(1) The door control device 80 operates the first door 30 and the second door 40 when an operation command signal is transmitted while the first door 30 and the second door 40 are stopped. As described above, when the user who outputs the operation command signal has a clear purpose for operating the door, that is, when the user operates the door that is stopped, the door control device 80 operates the first door 30 and the second door 40. On the other hand, when the operation command signal is transmitted while at least one of the first door 30 and the second door 40 is in operation, the door control device 80 restricts the operation of the first door 30 and the second door 40. As described above, when the user who outputs the operation command signal does not have a clear purpose for operating the door, that is, when the user attempts to operate the door that is currently in operation, the door control device 80 restricts the operation of the first door 30 and the second door 40. In this way, the door control device 80 can safely operate the first door 30 and the second door 40.

(2) The door control device 80 does not stop the first door 30 and the second door 40 when the operation command signal is transmitted while the first door 30 and the second door 40 are in a reverse operation even when the first door 30 and the second door 40 are in an opening and closing operation. That is, since the door control device 80 continues the reverse operation of the first door 30 and the second door 40, it is possible to prevent a state in which the first door 30 and the second door 40 are in contact with an object or a state in which the first door 30 and the second door 40 are close to the object from being maintained.

(3) When one of the first door 30 and the second door 40 is stopped at the fully open position, the door control device 80 can open only the other door toward the fully open position based on the opening operation command signal. That is, the door control device 80 can open only the door stopped at a position different from the fully open position based on the opening operation command signal.

(4) When one of the first door 30 and the second door 40 is stopped at the fully closed position, the door control device 80 can close only the other door toward the fully closed position based on the closing operation command signal. That is, the door control device 80 can close only the door stopped at a position different from the fully closed position based on the closing operation command signal.

(5) In the vehicle 10, an opening through which the user gets on and off can be made larger by opening the first door 30 and the second door 40. That is, in many cases, the first door 30 and the second door 40 are simultaneously opened or closed. Therefore, the door control device 80 can effectively improve safety during the opening and closing operation of the first door 30 and the second door 40.

### MODIFICATIONS

The embodiment can be modified and implemented as follows. The embodiment and the following modifications can be implemented in combination with each other within a technically inconsistent range.

A switch for opening and closing the first door 30 and the second door 40 provided in the portable device 100 may be only one switch. That is, the switch provided in the portable device 100 may be a two-door opening and closing switch that opens and closes both the first door 30 and the second door 40. When the two-door opening and closing switch of the portable device 100 is operated, the wireless communication device 70 outputs an operation command signal for operating both the first door 30 and the second door 40.

Hereinafter, door control by the first control unit 81 and the second control unit 82 when the two-door opening and closing switch is operated will be described with reference to FIG. 6.

When the first door 30 and the second door 40 are stopped at the fully closed positions, the first door 30 and the second door 40 are in the state of being able to perform the opening operation. Therefore, when an operation command signal is transmitted while the first door 30 and the second door 40 are stopped at the fully closed positions, the first control unit 81 starts the opening operation of the first door 30, and the second control unit 82 starts the opening operation of the second door 40.

When the first door 30 and the second door 40 are stopped at the fully open positions, the first door 30 and the second door 40 are in the state of being able to perform the closing operation. Therefore, when an operation command signal is transmitted while the first door 30 and the second door 40 are stopped at the fully open positions, the first control unit 81 starts the closing operation of the first door 30, and the second control unit 82 starts the closing operation of the second door 40.

When the first door 30 and the second door 40 are stopped at the intermediate positions, the first door 30 and the second door 40 are in the state of being able to perform the opening operation and the closing operation. Here, when a case in which the first door 30 and the second door 40 are closed from the intermediate position and a case in which the first door 30 and the second door 40 are opened from the intermediate position are compared with each other, the latter can be said to be safer than the former in terms of ease of occurrence of pinching. In particular, when the user operates the two-door opening and closing switch, in a situation in which the operation directions of the first door 30 and the second door 40 cannot be grasped, the latter can be said to be safer than the former. Therefore, when an operation command signal is transmitted while the first door 30 and the second door 40 are stopped at the intermediate positions, the first control unit 81 starts the opening operation of the first door 30, and the second control unit 82 starts the opening operation of the second door 40. The same applies to a case in which the operation command signal is transmitted when one of the first door 30 and the second door 40 is stopped at the intermediate position and the other of the first door 30 and the second door 40 is stopped at the fully closed position.

When one of the first door 30 and the second door 40 is stopped at the fully open position and the other of the first door 30 and the second door 40 is stopped at the fully closed position, the one door can be closed or the other door can be opened. However, when one of the first door 30 and the second door 40 performs the opening operation and the other performs the closing operation, there is a high possibility that the operation modes of the first door 30 and the second door 40 become an operation mode not intended by the user. The same applies to a case in which one of the first door 30 and the second door 40 is stopped at the fully open position and the other of the first door 30 and the second door 40 is stopped at the intermediate position. Therefore, when the operation command signal is transmitted while the first door 30 is stopped at the fully open position and the second door 40 is stopped at a position different from the fully open position, the first control unit 81 restricts the operation of the first door 30, and the second control unit 82 starts the opening operation of the second door 40. Similarly, when the operation command signal is transmitted while the first door 30 is stopped at a position different from the fully open position and the second door 40 is stopped at the fully open position, the first control unit 81 starts the opening operation, and the second control unit 82 restricts the operation of the second door 40.

The case in which at least one of the first door 30 and the second door 40 is in the normal operation and the case in which at least one of the first door 30 and the second door 40 is in the reverse operation are the same as those of the above-described embodiment, and thus the description thereof will be omitted.

The door control device 80 according to the modification can prevent one of the first door 30 and the second door 40 from opening and the other from closing based on the operation command signal. That is, the door control device 80 can prevent the operation directions of the first door 30 and the second door 40 from being different from each other. When one of the first door 30 and the second door 40 is located at the fully open position and the other is not located at the fully open position, the door control device 80 opens the door that is not located at the fully open position. In other words, the door control device 80 gives priority to the opening operation of the door not located at the fully open position over the closing operation of the door located at the fully open position. Therefore, the door control device 80 can reduce the risk of causing a user a sense of danger due to the door closing unintentionally.

In the door control device 80 according to the modification, when the operation command signal is transmitted while the first door 30 and the second door 40 are stopped at the intermediate positions, the first control unit 81 may close the first door 30, or the second control unit 82 may close the second door 40. The same applies to a case in which one of the first door 30 and the second door 40 stops at the fully open position.

The door switches 33 and 43 may be sensors that can detect an intention of the user to operate the door. For example, the door switches 33 and 43 may be electrostatic sensors that determine whether a hand of the user approaches the door handles 32 and 42, or may be motion sensors that detect a hand motion of the user. The door switches 33 and 43 may be switches that detect a pulling operation of the door handles 32 and 42.

The first door 30 may include a touch sensor that detects contact with an object during the opening operation. The same applies to the second door 40. In this case, it is preferable that the first control unit 81 and the second control unit 82 determine whether to perform the reverse operation based on a detection result of the touch sensor when the first door 30 and the second door 40 are opened.

The first door 30 and the second door 40 may not include the touch sensors 34 and 44. In this case, the door control device 80 may not perform the control related to the reverse operation based on detection results of the touch sensors 34 and 44.

At least one of the first door 30 and the second door 40 may not be a slide door as long as the door is opened and closed by the drive unit. For example, at least one of the first door 30 and the second door 40 may be a swing door that swings around an axis extending in the up-down direction or the front-rear direction.

The vehicle body 20 may include a center pillar that defines the first opening 22 and the second opening 23 between the first opening 22 and the second opening 23. That is, the first opening 22 and the second opening 23 may not be connected in the front-rear direction.

The door opening 21 may be open to a rear portion of the vehicle body 20. In this case, a right half of the door opening 21 may be the first opening 22, and a left half of the door opening 21 may be the second opening 23. That is, the first door 30 is a right door that opens and closes the first opening 22, and the second door 40 is a left door that opens and closes the second opening 23.

The vehicle 10 may include the two-door opening switch 101 and the two-door closing switch 102 around a driver seat, such as an instrument panel.

The door control device 80 is not limited to a processing circuit that includes a CPU and a ROM and executes software processing. For example, the door control device 80 may include a dedicated hardware circuit that executes at least a part of the various types of processing executed in the above-described embodiment. Examples of the dedicated hardware circuit include an ASIC. The ASIC is an abbreviation for “Application Specific Integrated Circuit”. That is, the door control device 80 may have any one of the following configurations (a) to (c).

(a) A processing circuit that includes a processing device that executes all of the above processing according to a program, and a program storage device such as a ROM that stores the program.

(b) A processing circuit that includes a processing device and a program storage device that execute part of the above processing according to a program, and a dedicated hardware circuit that executes the remaining processing.

(c) A processing circuit that includes a dedicated hardware circuit that performs all of the above processing.

Here, there may be a plurality of software execution devices including a processing device and a program storage device, and a plurality of dedicated hardware circuits.

[Aspect 1] A door control device that solves the above problems is a door control device applied to a vehicle including a vehicle body having a first opening and a second opening adjacent to each other, a first door configured to open and close the first opening, a second door configured to open and close the second opening, a first drive unit configured to open and close the first door between a fully open position where the first opening is fully opened and a fully closed position where the first opening is fully closed, and a second drive unit configured to open and close the second door between a fully open position where the second opening is fully opened and a fully closed position where the second opening is fully closed. The door control device includes: a first control unit configured to control the first drive unit based on the operation command signal; and a second control unit configured to control the second drive unit based on the operation command signal, the operation command signal being a signal for operating both the first door and the second door. When the operation command signal is transmitted to the first control unit and the second control unit while the first door and the second door are stopped, the first control unit starts an operation of the first door and the second control unit starts an operation of the second door, and when the operation command signal is transmitted to the first control unit and the second control unit while at least one of the first door and the second door is in an opening and closing operation, the first control unit restricts the operation of the first door, and the second control unit restricts the operation of the second door.

The door control device operates the first door and the second door when an operation command signal is transmitted while the first door and the second door are stopped. As described above, when the user who outputs the operation command signal has a clear purpose for operating the door, that is, when the user operates the door that is stopped, the door control device operates the first door and the second door. On the other hand, when the operation command signal is transmitted while at least one of the first door and the second door is in operation, the door control device restricts the operation of the first door and the second door. For example, the door control device stops the first door when the first door is in operation, and maintains a state in which the first door is stopped when the first door is stopped. As described above, when the user who outputs the operation command signal does not have a clear purpose for operating the door, that is, when the user attempts to operate the door that is currently in operation, the door control device restricts the operation of the first door and the second door. In this way, the door control device can safely operate the first door and the second door.

[Aspect 2] In the door control device according to Aspect 1, the vehicle includes a first touch sensor configured to detect contact of an object with the first door during an opening and closing operation, and a second touch sensor configured to detect contact of an object with the second door during an opening and closing operation. The first control unit starts a reverse operation to reverse an operation direction of the first door when the first touch sensor detects the contact with the object during the opening and closing operation of the first door. The second control unit starts a reverse operation to reverse an operation direction of the second door when the second touch sensor detects the contact with the object during the opening and closing operation of the second door. When the operation command signal is transmitted to the first control unit and the second control unit while the first door is in the reverse operation, the first control unit continues the reverse operation of the first door, and when the operation command signal is transmitted to the first control unit and the second control unit while the second door is in the reverse operation, the second control unit continues the reverse operation of the second door.

The door control device does not stop the first door and the second door when the operation command signal is transmitted while the first door and the second door are in a reverse operation even when the first door and the second door are in an opening and closing operation. That is, since the door control device continues the reverse operation of the first door and the second door, it is possible to prevent a state in which the first door and the second door are in contact with an object or a state in which the first door and the second door are close to the object from being maintained.

[Aspect 3] In the door control device according to Aspect 1 or 2, the operation command signal includes an opening operation command signal for opening both the first door and the second door. When the opening operation command signal is transmitted to the first control unit and the second control unit while the first door is stopped at a position different from the fully open position and the second door is stopped at the fully open position, the first control unit starts an opening operation of the first door, and the second control unit restricts the operation of the second door, and when the opening operation command signal is transmitted to the first control unit and the second control unit while the first door is stopped at the fully open position and the second door is stopped at a position different from the fully open position, the first control unit restricts the operation of the first door and the second control unit starts an opening operation of the second door.

When one of the first door and the second door is stopped at the fully open position, the door control device can open the other door toward the fully open position based on the opening operation command signal. That is, the door control device can open only the door stopped at a position different from the fully open position based on the opening operation command signal.

[Aspect 4] In the door control device according to any one of Aspects 1 to 3, the operation command signal includes a closing operation command signal for closing both the first door and the second door. When the closing operation command signal is transmitted to the first control unit and the second control unit while the first door is stopped at a position different from the fully closed position and the second door is stopped at the fully closed position, the first control unit starts a closing operation of the first door, and the second control unit restricts the operation of the second door, and when the closing operation command signal is transmitted to the first control unit and the second control unit while the first door is stopped at the fully closed position and the second door is stopped at a position different from the fully closed position, the first control unit restricts the operation of the first door and the second control unit starts a closing operation of the second door.

When one of the first door and the second door is stopped at the fully closed position, the door control device can close the other door toward the fully closed position based on the closing operation command signal. That is, the door control device can close only the door stopped at a position different from the fully closed position based on the closing operation command signal.

[Aspect 5] In the door control device according to Aspect 1 or 2, when the operation command signal is transmitted to the first control unit and the second control unit while the first door and the second door are stopped at the fully closed positions, the first control unit starts an opening operation of the first door and the second control unit starts an opening operation of the second door. When the operation command signal is transmitted to the first control unit and the second control unit while the first door and the second door are stopped at the fully open positions, the first control unit starts a closing operation of the first door and the second control unit starts a closing operation of the second door. When the operation command signal is transmitted to the first control unit and the second control unit while the first door is stopped at a position different from the fully open position and the second door is stopped at the fully open position, the first control unit starts the opening operation of the first door, and the second control unit restricts the operation of the second door, and when the operation command signal is transmitted to the first control unit and the second control unit while the first door is stopped at the fully open position and the second door is stopped at a position different from the fully open position, the first control unit restricts the operation of the first door and the second control unit starts the opening operation of the second door.

The door control device can prevent one of the first door and the second door from opening and the other from closing based on the operation command signal. That is, the door control device can prevent the operation directions of the first door and the second door from being different from each other. When one of the first door and the second door is located at the fully open position and the other is not located at the fully open position, the door control device opens the door that is not located at the fully open position. In other words, the door control device gives priority to the opening operation of the door not located at the fully open position over the closing operation of the door located at the fully open position. Therefore, the door control device can reduce the risk of causing a user a sense of danger due to the door closing unintentionally.

[Aspect 6] In the door control device according to any one of Aspects 1 to 5, the first opening and the second opening form a single opening that opens in a side portion of the vehicle and is connected in a front-rear direction. The first door is a front slide door that opens and closes the first opening by sliding in the front-rear direction, and the second door is a rear slide door that opens and closes the second opening by sliding in the front-rear direction.

In the above-described vehicle, an opening through which the user gets on and off can be made larger by opening the first door and the second door. That is, in many cases, the first door and the second door are simultaneously opened or closed. Therefore, the door control device can effectively improve safety during the opening and closing operation of the first door and the second door.

The door control device can prevent giving a sense of danger to a user when the first door and the second door are operated.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A door control device applied to a vehicle including a vehicle body having a first opening and a second opening adjacent to each other, a first door configured to open and close the first opening, a second door configured to open and close the second opening, a first drive unit configured to open and close the first door between a fully open position where the first opening is fully opened and a fully closed position where the first opening is fully closed, and a second drive unit configured to open and close the second door between a fully open position where the second opening is fully opened and a fully closed position where the second opening is fully closed, the door control device comprising:
a first control unit configured to control the first drive unit based on the operation command signal; and
a second control unit configured to control the second drive unit based on the operation command signal,
the operation command signal being a signal for operating both the first door and the second door, wherein
when the operation command signal is transmitted to the first control unit and the second control unit while the first door and the second door are stopped, the first control unit starts an operation of the first door and the second control unit starts an operation of the second door, and
when the operation command signal is transmitted to the first control unit and the second control unit while at least one of the first door and the second door is in an opening and closing operation, the first control unit restricts the operation of the first door, and the second control unit restricts the operation of the second door.

2. The door control device according to claim 1, wherein
the vehicle includes a first touch sensor configured to detect contact of an object with the first door during an opening and closing operation, and a second touch sensor configured to detect contact of an object with the second door during an opening and closing operation,
the first control unit starts a reverse operation to reverse an operation direction of the first door when the first touch sensor detects the contact with the object during the opening and closing operation of the first door,
the second control unit starts a reverse operation to reverse an operation direction of the second door when the second touch sensor detects the contact with the object during the opening and closing operation of the second door,
when the operation command signal is transmitted to the first control unit and the second control unit while the first door is in the reverse operation, the first control unit continues the reverse operation of the first door, and
when the operation command signal is transmitted to the first control unit and the second control unit while the second door is in the reverse operation, the second control unit continues the reverse operation of the second door.

3. The door control device according to claim 1, wherein
the operation command signal includes an opening operation command signal for opening both the first door and the second door,
when the opening operation command signal is transmitted to the first control unit and the second control unit while the first door is stopped at a position different from the fully open position and the second door is stopped at the fully open position, the first control unit starts an opening operation of the first door, and the second control unit restricts the operation of the second door, and
when the opening operation command signal is transmitted to the first control unit and the second control unit while the first door is stopped at the fully open position and the second door is stopped at a position different from the fully open position, the first control unit restricts the operation of the first door and the second control unit starts an opening operation of the second door.

4. The door control device according to claim 1, wherein
the operation command signal includes a closing operation command signal for closing both the first door and the second door,
when the closing operation command signal is transmitted to the first control unit and the second control unit while the first door is stopped at a position different from the fully closed position and the second door is stopped at the fully closed position, the first control unit starts a closing operation of the first door, and the second control unit restricts the operation of the second door, and
when the closing operation command signal is transmitted to the first control unit and the second control unit while the first door is stopped at the fully closed position and the second door is stopped at a position different from the fully closed position, the first control unit restricts the operation of the first door and the second control unit starts a closing operation of the second door.

5. The door control device according to claim 1, wherein
when the operation command signal is transmitted to the first control unit and the second control unit while the first door and the second door are stopped at the fully closed positions, the first control unit starts an opening operation of the first door and the second control unit starts an opening operation of the second door,
when the operation command signal is transmitted to the first control unit and the second control unit while the first door and the second door are stopped at the fully open positions, the first control unit starts a closing operation of the first door and the second control unit starts a closing operation of the second door,
when the operation command signal is transmitted to the first control unit and the second control unit while the first door is stopped at a position different from the fully open position and the second door is stopped at the fully open position, the first control unit starts the opening operation of the first door, and the second control unit restricts the operation of the second door, and
when the operation command signal is transmitted to the first control unit and the second control unit while the first door is stopped at the fully open position and the second door is stopped at a position different from the fully open position, the first control unit restricts the operation of the first door and the second control unit starts the opening operation of the second door.

6. The door control device according to claim 1, wherein
the first opening and the second opening form a single opening that opens in a side portion of the vehicle and is connected in a front-rear direction,
the first door is a front slide door that opens and closes the first opening by sliding in the front-rear direction, and
the second door is a rear slide door that opens and closes the second opening by sliding in the front-rear direction.

7. The door control device according to claim 2, wherein
the operation command signal includes an opening operation command signal for opening both the first door and the second door,
when the opening operation command signal is transmitted to the first control unit and the second control unit while the first door is stopped at a position different from the fully open position and the second door is stopped at the fully open position, the first control unit starts an opening operation of the first door, and the second control unit restricts the operation of the second door, and
when the opening operation command signal is transmitted to the first control unit and the second control unit while the first door is stopped at the fully open position and the second door is stopped at a position different from the fully open position, the first control unit restricts the operation of the first door and the second control unit starts an opening operation of the second door.

8. The door control device according to claim 2, wherein
the operation command signal includes a closing operation command signal for closing both the first door and the second door,
when the closing operation command signal is transmitted to the first control unit and the second control unit while the first door is stopped at a position different from the fully closed position and the second door is stopped at the fully closed position, the first control unit starts a closing operation of the first door, and the second control unit restricts the operation of the second door, and
when the closing operation command signal is transmitted to the first control unit and the second control unit while the first door is stopped at the fully closed position and the second door is stopped at a position different from the fully closed position, the first control unit restricts the operation of the first door and the second control unit starts a closing operation of the second door.

9. The door control device according to claim 2, wherein
when the operation command signal is transmitted to the first control unit and the second control unit while the first door and the second door are stopped at the fully closed positions, the first control unit starts an opening operation of the first door and the second control unit starts an opening operation of the second door,
when the operation command signal is transmitted to the first control unit and the second control unit while the first door and the second door are stopped at the fully open positions, the first control unit starts a closing operation of the first door and the second control unit starts a closing operation of the second door,
when the operation command signal is transmitted to the first control unit and the second control unit while the first door is stopped at a position different from the fully open position and the second door is stopped at the fully open position, the first control unit starts the opening operation of the first door, and the second control unit restricts the operation of the second door, and
when the operation command signal is transmitted to the first control unit and the second control unit while the first door is stopped at the fully open position and the second door is stopped at a position different from the fully open position, the first control unit restricts the operation of the first door and the second control unit starts the opening operation of the second door.

10. The door control device according to claim 2, wherein
the first opening and the second opening form a single opening that opens in a side portion of the vehicle and is connected in a front-rear direction,
the first door is a front slide door that opens and closes the first opening by sliding in the front-rear direction, and
the second door is a rear slide door that opens and closes the second opening by sliding in the front-rear direction.
